(19) United States
(12) Patent Application Publication
(10) Pub. No.: US 2002/0063958 A1
(43) Pub. Date: May 30, 2002

(54) Method for manufacturing a 3D image display body and film for use in forming 3D image display body

(76) Inventors: Kazuo Maeda, Joetsu-shi (JP); Yoshihiro Yoshihara, Nakakubiki-gun (JP)

Correspondence Address: Gerow D. Brill, Reveo, Inc., 85 Executive Blvd., Elmsford, NY, 10523, US

(21) Appl. No.: 09/873,509

(22) Filed: Jun. 4, 2001

(30) Foreign Application Priority Data
Jun. 15, 1999 (JP) 11-168957
Mar. 6, 2001 (JP) 2001-59949
Jan. 13, 2001 (KR) 10-2001-0002020

(51) Int. Cl. G02B 27/22; G02B 27/26

(52) U.S. Cl. 359/465; 359/462

(57) ABSTRACT

The present invention provides a method for manufacturing a 3D image display body which is used to display 3D images in which right-eye image display parts a and left-eye image display parts b are mixed, said method includes a phase-difference film is disposed on a transparent support with an adhesive agent interposed. Transparent resist members are then disposed in specified positions on the aforementioned phase-difference film. The resulting assembly is then immersed in hot water and dried. A protective member is then disposed on the side of the resist members, and the aforementioned protective member and a display member 5 are then superimposed or bonded.

### BACKGROUND OF THE INVENTION

The present invention relates to a method for manufacturing a 3D image display body, which is used to display 3D images, and a film for use in forming such a 3D image display body. 3D image display devices such as that disclosed in (for example) USP 5,327,285 ('285) by Faris have been proposed in the past. The '285 patent is hereby incorporated by reference. In this 3D image display device, as is shown in FIG. 1, a film 52 in which the right-eye image display parts a and the left-eye image display parts b are alternately disposed side by side is bonded to the surface of a liquid crystal member 51. When the light emitted by the liquid crystal member 51 is controlled so that a specified image is displayed, a right-eye image is displayed from the right-eye image display parts a, and a left-eye image is displayed from the left-eye image display parts b. Furthermore, since the device is constructed so that the direction of vibration of the polarized light constituting the right-eye image from the right-eye image display parts a has an angle of 90° relative to the direction of vibration of the polarized light constituting the left-eye image from the left-eye image display parts b (i.e., since the device is constructed so that (for example) the x component of the right-eye image consisting of two components x and y has a phase difference of 180° (π) with respect to the x component of the left-eye image which similarly consists of two components x and y), the observer can experience the sensation of observing a three-dimensional image when the aforementioned image is viewed using polarizing eyeglasses consisting of a polarizer-equipped right-eye lens that transmits only the right-eye image and a polarizer-equipped left-eye lens that transmits only the left-eye image.

With regard to the method used to manufacture the aforementioned film 52 in which the right-eye image display parts a and the left-eye image display parts b are alternately disposed side by side, such as film 52 has been manufactured in the past by a method in which a polarizing film formed by laminating a TAC film and an iodine-treated drawn PVA film is coated with a photoresist, specified portions of this coated film are exposed, and the film is then treated with a potassium hydroxide solution, so that the property that the drawn PVA film possesses of being able to rotate the direction of vibration of light in a specified wavelength region “as is” in a linearly polarized state (phase-difference function) is eliminated, as disclosed in FIG. 2 of the aforementioned '285 patent. In this method, however, exposure and treatment with a potassium hydroxide solution must be performed following the application of the photoresist coating, so that this method is extremely troublesome. Several types of methods for manufacturing a film 52 by means of such a chemical treatment, and methods for manufacturing a film 52 by means of a physical treatment, etc., are disclosed in the '285 patent. However, all of these manufacturing methods are similarly troublesome.

The present invention provides a film in which right-eye image display parts a and left-eye image display parts b are mixed, and a method for manufacturing the same, which are greatly simplified and superior in terms of productivity.

### SUMMARY OF THE INVENTION

The object of the present invention is to allow the easy production of a film that has the right-eye image display parts a and the left-eye image display parts b.

### BRIEF DESCRIPTION OF THE DRAWINGS

The embodiments of the present invention are described with reference to the attached figures, wherein:

FIG. 1 is an explanatory diagram of a conventional 3D image display device; and

FIG. 2 is an explanatory diagram of the construction of an embodiment of the present invention.

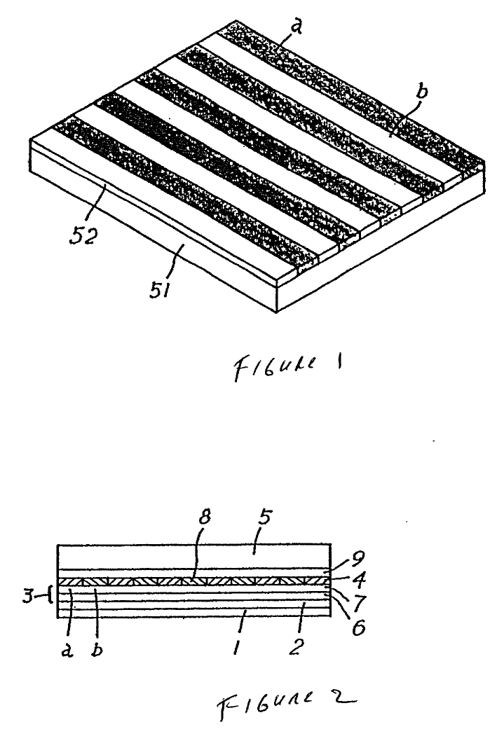

### DETAILED DESCRIPTION OF THE INVENTION

The present invention relates to a method for manufacturing a 3D image display body which is used to display 3D images in which right-eye image display parts a and left-eye image display parts b are mixed. The 3D image display body manufacturing method includes a phase-difference film that is disposed on a transparent support 1 with an adhesive agent 2 interposed. Transparent resist members 4 are then disposed in specified positions on the aforementioned phase-difference film. The resulting assembly is then immersed in hot water and dried. A protective member 9 is then disposed on the side of the resist members 4, and the aforementioned protective member 9 and a display member 5 are then superimposed or bonded.

Furthermore, the present invention also relates to a method for manufacturing a 3D image display body which is used to display 3D images in which right-eye image display parts a and left-eye image display parts b are mixed. The 3D image display body manufacturing method includes a laminated phase-difference film 3 formed by laminating a TAC film 6 or CAB film, etc., that does not possess birefringence and a drawn PVA film 7 that has a phase-difference function is disposed on a transparent support 1 with an adhesive agent 2 interposed so that the TAC film 6, etc., is located on the side of the adhesive agent 2. Transparent resist members 4 are then disposed in specified positions on the drawn PVA film 7. The resulting assembly is then immersed in hot water and dried. A protective member 9 is then disposed on the side of the resist members 4, and the aforementioned protective member 9 and a display member 5 are then superimposed or bonded.

Furthermore, the present invention also relates to a method for manufacturing a 3D image display body which is used to display 3D images in which right-eye image display parts a and left-eye image display parts b are mixed. The 3D image display body manufacturing method includes a laminated phase-difference film 3 formed by laminating a TAC film 6 or CAB film, etc., that does not possess birefringence and a drawn PVA film 7 that has a phase-difference function is disposed on a transparent support 1 with an adhesive agent 2 interposed so that the TAC film 6, etc., is located on the side of the adhesive agent 2. Resist members 4 are then disposed in specified positions on the drawn PVA film 7. The resulting assembly is then immersed in hot water and dried. The spaces between the resist members 4 are then filled with appropriate members 8, and a protective member 9 is disposed on the side of these appropriate members 8 and resists members 4. The aforementioned protective member 9 and a display member 5 are then superimposed or bonded.

Furthermore, the present invention also relates to a 3D image display body manufacturing method, which additionally includes members that do not possess birefringence are used as the above-mentioned appropriate members 8 and protective member 9.

Furthermore, relates to a film for use in forming a 3D image display body which is used to display a 3D image in which right-eye image display parts a and left-eye image display parts b are mixed, said film for use in forming a 3D image display body which further includes a laminated phase-difference film 3 formed by laminating a film that does not possess birefringence, such as a TAC film 6, etc., and a drawn PVA film 7 that has a phase-difference function is disposed on a transparent support 1 with an adhesive agent 2 interposed so that the film that does not possess birefringence is located on the side of the adhesive agent 2. The right-eye image display parts a and the left-eye image display parts b are disposed in specified positions on this drawn PVA film 7. Transparent resist members 4 are further disposed on this drawn PVA film 7, and a protective member 9 is disposed on these resist members 4.

Furthermore, the present invention also relates to a film for use in forming a 3D image display body, which further includes the spaces between the resist members 4 that are filled with appropriate members 8.

When the above-mentioned assembly is immersed in hot water after the transparent resist members 4 have been disposed in specified positions on the phase-difference film, water permeates the portions of the phase-difference film where no resist members 4 are present, so that these portions show a change in properties. As a result, the property of being able to rotate the direction of vibration of light in a specified wavelength region “as is” in a linearly polarized state (phase-difference function) is lost only in the above-mentioned portions of the film, thus producing a film in which the phase of the transmitted light is shifted 180° between portions where resist members 4 are present and portions where no resist members 4 are present.

Accordingly, a film in which the right-eye image display parts a and the left-eye image display parts b are mixed can be mass-produced by the simple operation of immersion in hot water.

In the present invention, since hot water is caused to permeate into specified portions of the phase-difference film, there is a danger that these portions may show local swelling, elution or the appearance of recessed and protruding interfaces, etc. In this regard, however, a protective member 9 is installed in the present invention. Accordingly, the resistance of the display body as a whole to moist heat is improved, and the problem of swelling, etc., of the aforementioned phase-difference film is solved. Consequently, the reliability of the display body is correspondingly improved.

Furthermore, since the spaces between the resist members 4 are filled with appropriate members 8, the surface is flattened; accordingly, the diffusion of light is correspondingly suppressed, so that the resolution and contrast are improved.

FIG. 2 illustrates an embodiment of the present invention, which will be described in detail below.

A laminated phase-difference film 3 formed by laminating a TAC film 6 (thickness: 126 μm) and a uniaxially drawn PVA film 7 (thickness: 38 μm) as a phase-difference film (½-wave plate) which has a phase-difference function is disposed on the surface of a transparent support 1 (e.g., a glass plate or cellulose acetate butyrate (CAB) plate, etc., with a thickness of about 2 mm) with an adhesive agent 2 (e.g., an ultraviolet-curable resin) interposed, and the ultraviolet-curable resin is cured by means of ultraviolet light. Furthermore, a glass plate that does not possess birefringence is most desirable as the support 1. Moreover, besides a film formed by laminating a TAC film 6 with a drawn PVA film 7, the laminated phase-difference film 3 may also be a film formed by laminating a CAB film with a drawn PVA film 7. In short, any film formed by laminating a film that does not possess birefringence with a drawn PVA film 7 may be used as the laminated phase-difference film 3.

Next, a transparent resist ink which has a high water resistance and high adhesion (e.g., a urethane resin type adhesive agent) is applied by screen printing as resist members 4 in specified positions on the above-mentioned uniaxially drawn PVA film 7. The resist ink in this case is applied in the form of linear bodies with a width of 160 μm, which are applied to the surface of the drawn PVA film 7 from one side to the other. These linear bodies are disposed side by side at a pitch of 160 μm.

Furthermore, it is not necessary that the resist ink have a uniform width and uniform pitch as described above. Moreover, the ink need not be applied in the form of linear bodies; it would also be possible, for example, to dispose square bodies (as seen in a plan view) in a staggered arrangement.

Next, this assembly is immersed for approximately 30 seconds in hot water at a temperature of 80° C. (of course, the peripheral surfaces are subjected to an appropriate waterproofing treatment), so that the orientation of the molecules in the drawn PVA film 7 is destroyed by allowing water to permeate into the portions where no resist ink is present, thus eliminating the aforementioned phase-difference function that was present in the state prior to drawing, i.e., the phase-difference function] that is intrinsically possessed by the drawn PVA film 7. In this way, the portions where the resist ink is present are converted into (for example) right-eye image display parts a, and the portions where no resist ink is present are converted into left-eye image display parts b. As a result of various experiments, it has been confirmed that the properties of the above-mentioned drawn PVA film 7 are similarly lost if the film is immersed for 5 seconds to 10 minutes in hot water at a temperature of 80° C. to 100° C.

Then, a UV resin, PVA-type adhesive agent or acrylic-type tacky adhesive agent, etc., is applied to the surface of the drawn PVA film 7 as appropriate members 8 in the spaces between the resist ink. Furthermore, a TAC or CAB sheet is laminated as a protective member 9. Moreover, the appropriate members 8 and protective member 9 may be any members that do not possess birefringence, so that there is no change in phase.

Then, a 3D image display body is formed by superimposing the above-mentioned assembly by means of a magnet, etc., on a display member 5 which has a liquid crystal disposed inside, or bonding the above-mentioned assembly to such a display member 5 by means of an appropriate adhesive agent.

The positions where the resist ink is applied, i.e., the positions of the right-eye image display parts a and left-eye image display parts b, are set so that they coincide with the pitch of the liquid crystal cells of the display member 5 that is bonded.

A film in which right-eye image'display parts a and left-eye image display parts b are disposed side by side can easily be obtained by means of the above manufacturing method; accordingly, a 3D image display body can also easily be obtained.

Generally, PVA has a poor resistance to moist heat. Furthermore, in the present embodiment, hot water is caused to permeate specified portions of the drawn PVA film 7; accordingly, there is a danger that that these portions may show local swelling, elution or the appearance of recessed and protruding interfaces, etc. In this regard, however, a protective member 9 is installed in the present embodiment; accordingly, the resistance of the display body as a whole to moist heat is improved, and the problem of swelling, etc., of the aforementioned phase-difference film 7 is solved. Consequently, the reliability of the display body is correspondingly improved. Furthermore, since the spaces between the resist members 4 are filled with appropriate members 8, the surface is flattened; accordingly, the diffusion of light is correspondingly suppressed, so that the resolution and contrast are improved.

In concrete terms, when a member formed by laminating a support, a UV adhesive agent, a TAC film and a PVA film in that order was subjected to a general moist heat test for household electrical materials (conditions: 40° C.×95% RH), peeling occurred within 24 hours at one of the interfaces, i.e., the interface between the support member and the UV adhesive agent, the interface between the UV adhesive agent and the TAC film, or the interface between the TAC film and the PVA film. In the case of the present embodiment, however, it was confirmed that no abnormalities in external appearance such as peeling, etc., occurred in 500 hours under the above-mentioned conditions.

Furthermore, if the respective members are provided in the form of rolls in the above-mentioned manufacturing process, continuous manufacture is possible, so that the productivity of the 3D image display body is improved even further.

When the image from the 3D image display body manufactured as described above is viewed through polarizing eyeglasses consisting of a polarizer-equipped right-eye lens that transmits only the right-eye image from the right-eye image display parts a and a polarizer-equipped left-eye lens that transmits only the left-eye image from the left-eye image display parts b (i.e., an image that is composed of light that vibrates in a direction that is 90° perpendicular to the direction of vibration of the light composing the right-eye image), the observer can experience the sensation of viewing the above-mentioned image as a three-dimensional image.

It is understood that method of manufacturing a 3D image display body may be modified in a variety of ways which will become readily apparent to those skilled in the art of having the benefit of the teachings disclosed herein. All such modifications and variations of the illustrative embodiments thereof shall be deemed to be within the scope and spirit of the present invention as defined by the claims to the invention appended hereto.

What is claimed is:

1. A method for manufacturing a 3D image display body which is used to display 3D images in which right-eye image display parts and left-eye image display parts are mixed, said 3D image display body manufacturing method comprising:
disposing a phase-difference film on a transparent support with an adhesive agent interposed:
further disposing transparent resist members in specified positions on said phase-difference film;
immersing a resulting assembly in hot water and dried,
furthur disposing a protective member on a side of the resist members: and
superimposing or bonding said protective member and a display member.

2. A method for manufacturing a 3D image display body which is used to display 3D images in which right-eye image display parts and left-eye image display parts are mixed, said 3D image display body manufacturing method comprising:
laminating a laminated phase-difference film formed by laminating a TAC film or CAB film, that does not possess birefringence and a drawn PVA film that has a phase-difference function;
disposing said laminated phase difference film onto a transparent support with an adhesive agent interposed so that said TAC film is located on a side of said adhesive agent;
disposing transparent resist members in specified positions on said drawn PVA film:
immersing said resulting assembly in hot water and dried;
a protective member is then disposed on the side of the resist members, and
the aforementioned protective member and a display member are then superimposed or bonded.

3. A method for manufacturing a 3D image display body which is used to display 3D images in which right-eye image display parts and left-eye image display parts are mixed, said 3D image display body manufacturing method comprising:
a laminated phase-difference film formed by laminating a TAC film or CAB film that does not possess birefringence and a drawn PVA film that has a phase-difference function is disposed on a transparent support with an adhesive agent interposed so that the TAC film is located on the side of the adhesive agent;
resist members are then disposed in specified positions on the drawn PVA film:
the resulting assembly is then immersed in hot water and dried;
the spaces between the resist members are then filled with appropriate members, and a protective member is disposed on the side of these appropriate members and resist members; and
the aforementioned protective member and a display member are then superimposed or bonded.

4. The method of either claim 2 wherein members that do not possess birefringence are used as the appropriate members and protective member.

5. The method of either claim 3 wherein members that do not possess birefringence are used as the appropriate members and protective member.

6. A film for use in forming a 3D image display body that is used to display a 3D image in which right-eye image display parts and left-eye image display parts are mixed, said film for use in forming a 3D image display body comprising:
a laminated phase-difference film formed by laminating a film that does not possess birefringence, such as a TAC film and a drawn PVA film that has a phase-difference function is disposed on a transparent support with an adhesive agent interposed so that the film that does not possess birefringence is located on the side of the adhesive agent;
right-eye image display parts and left-eye image display parts are disposed in specified positions on this drawn PVA film; and
transparent resist members are further disposed on this drawn PVA film, and a protective member is disposed on these resist members.

7. The film of claim 6 wherein the spaces between the resist members are filled with appropriate members.
